(19) United States
(12) Patent Application Publication
(10) Pub. No.: US 2011/0064898 A1
(43) Pub. Date: Mar. 17, 2011

(54) Thermoplastic Polyurethanes With Good Fuel Resistance

(75) Inventors: Julius Farkas, North Ridgeville, OH (US); Larry E. Hewitt, Vermillion, OH (US); Charles P. Jacobs, Elyria, OH (US); Sridhar K. Siddhamalli, Luiz, FL (US); Joseph J. Vontorcik, Broadview Heights, OH (US)

(73) Assignee: Lubrizol Advanced Materials, Inc., Cleveland, OH (US)

(21) Appl. No.: 12/992,097

(22) PCT Filed: May 12, 2009
(86) PCT No.: PCT/US09/43529

§ 371 Date: Nov. 11, 2010

Related U.S. Application Data
(60) Provisional application No. 61/054,176, filed on May 19, 2008.

(51) Int. Cl. B32B 1/02; C08G 18/00; C08L 75/06; C08K 5/12

(52) U.S. Cl. 428/36.1; 428/36.92; 528/80; 524/589; 524/294

(57) ABSTRACT

A high molecular weight, thermoplastic polyurethane composition characteristically resistant to aliphatic hydrocarbon fuels, where the polyurethane composition is adapted for use as an aliphatic hydrocarbon fuel barrier in the construction of flexible fuel containers, and the polyurethane is the reaction product of a poly(diethylene adipate) glycol reacted with a non-hindered diisocyanate and an aliphatic chain extender.

### BACKGROUND OF THE INVENTION

The present invention is directed to polyurethane compositions which are synthesized front poly(diethylene adipate) glycol and exhibit excellent resistance toward fuels, especially alcohol-containing fuels.

Flexible fuel tanks utilized for the storage of fuels, such as gasoline or jet fuel require extended fuel resistance and hydrolytic stability along with toughness, resiliency, and sufficient flexibility to maintain strength and integrity in weather extremes while in constant contact with aliphatic hydrocarbon fuels. Although, generally, thermoplastic polymers and particular thermoplastic polyurethanes can provide flexibility, they invariably do not exhibit adequate structural strengths and flexibility and lack long term resistance to hydrocarbon liquid fuels as well as necessary hydrolytic stability. The physical properties and specifications of polymers, polymeric composites, and flexible fuel tanks constructed from them are set forth in MIL T52983B (Sept. 17, 1984) and the test for fuel resistance is set forth in ASTM D471-79 and particularly for resistance to fuels B and D. Fuel tanks generally have been suggested based on polyurethane polymers. In U.S. Pat. No. 4,487,913, for instance, complex thermosetting polyurethane polymers are crosslinked in the construction of aircraft fuel tanks typically comprising rigid structures, Similarly, U.S. Pat. No. 4,565,729 discloses a multilayer rigid laminate for rigid structural fuel tanks used on aircraft based on thermosetting amine crosslinked polyurethane polymers,

Polyurethane coated fabrics used in unrelated flexible fabric constructions are disclosed in U.S. Pat. No. 4,689,385 (face masks) and U.S. Pat. No, 2,657,151 (raincoats). Unreinforced thermoplastic poi urethane elastomers for general use are disclosed in U.S. Pat. No. 4,169,196, U.S. Pat. No, 3,528,948 and U.S. Pat. No. 3,706,710 based on polyester polyols reacted with diisocyanates and extended with low molecular weight diols. In addition to not being combined with fabrics for either rigid or flexible reinforced products, the polymers disclosed in these patents are merely general purpose polyurethane elastomers which do not necessarily exhibit high resistance to aliphatic hydrocarbon fuels or hydrolytic resistance or other structural and utility characteristics necessary for the construction of flexible fuel tanks. Other polyurethane polymers including polyester based polyurethanes are disclosed in the following patents: U.S. Pat. No. 2,871,218 disclosing extruded plastic sheets resistant to hydrocarbon solvents but soluble in polar solvents; U.S. Pat. No, 4,400,498 pertaining to heat and solvent resistant crosslinked polyurethanes particularly adapted to disperse fillers and pigments and useful for adhesives; U.S. Pat. No. 4,191,818 directed to heat resistant, crosslinked crystalline polyurethanes used in elastomeric cast moldings; U.S. Pat. No. 3,214,411 suggesting polyester polyurethane polymers adapted to be heat crosslinked in high heat injection molding processes; and U.S. Pat. No 3,012,992 disclosing load bearing, crosslinked polyurethane castings and plastics. U.S. Pat. No. 4,439,552 discloses cellular polyurethane foams, whereas U.S. Pat. No. 4,762,884 discloses radiation activated crosslinked polyurethanes.

The physical, chemical and structural requirements for flexible fuel tanks include prolonged flexibility and durability, resiliency and toughness, especially prolonged, hydrocarbon fuel resistance and hydrolytic stability, high tensile strength before and after immersion in water or fuel, and certain stress-strain requirements such as tensile strength, percent elongation, and modulus. However, various polyurethane polymers ordinarily considered to exhibit excellent physical properties have been fbund inadequate. Polyurethane polymers based on polycaprolactone polyol, polytetramethylene ether glycol, and poly(tetrarnethylene adipate) glycol, are unsatisfactory and in particular lack satisfactory resistance to aliphatic hydrocarbon fuels. Polycaprolactone polyurethanes and polyether polytetramethylene ether glycol polyurethanes, for example, exhibited adequate hydrolytic stability but lacked sufficient resistance to liquid, hydrocarbon fuels.

U.S. Pat. No 5,047,495 to E. G. Kolycheck teaches a high molecular weight thermoplastic polyurethane which is the polymeric reaction product of an ethylene ether oligomer glycol intermediate co-reacted with a non-hindered diisocyanate and an extender glycol. The ethylene ether oligomer glycol intermediate is (a) a diethvlene glycol-aliphatic linear polyester or (b) a polyethylene glycol and has a number average molecular weight from about 500 to about 5,000 Daltons. The resulting polyurethane polymer has a weight average molecular weight from about 60,000 to about 500,000 Daltons, exhibits excellent fuel resistance, and is used in reinforced fabric molded flexible fuel tanks or containers for storage of gasoline or jet fuels.

Beyond gasoline and jet fuel, specialty blends of gasolines, such as E85, which is an environmentally friendlier gasoline blend of 85% ethanol and 15% gasoline, have led to a need for better materials for storage of fuels. These materials need to provide excellent resistance toward the fuel, while being able to be shaped into containers for the fuels.

### SUMMARY OF THE INVENTION

A high molecular weight, thermoplastic polyurethane (or TPU) composition characteristically resistant to aliphatic hydrocarbon fuels, where the polyurethane composition is adapted for use as an aliphatic hydrocarbon fuel barrier in the construction of flexible fuel containers, and the polyurethane is the reaction product of a poly(diethylene adipate) glycol reacted with a non-hindered diisocyanate and an aliphatic chain extender.

### DETAILED DESCRIPTION OF THE INVENTION

The present invention is directed to polyurethane compositions which are synthesized from poly(diethylene glycol) adipate, which is reacted with a non-hindered diisocyanate and an aliphatic chain extender to form the polymer. The polyurethane composition exhibits excellent resistance toward fuels, especially alcohol-containing fuels. The compositions can be plasticized and used in the molding of fabric reinforced, portable flexible fuel containers. The plasticized compositions exhibit better cold temperature snap back characteristics in addition to enhanced fuel resistance.

In the preferred embodiment, the polyurethane is synthesized from poly(diethylene adipate) glycol as the maeroglycol, 1,4-butanediol as the chain extender, and methylene diphenyl isocyanate (MDI) as the diisocyanate. The preferred plasticizer to be incorporated into the thermoplastic polyurethane (TPU) is benzyl butyl phthalate. Benzyl butyl phthalate is commercially available as Santicizer 160 from the Ferro Corporation.

TPU polymers may be prepared by reacting a polyisocyanate with an intermediate such as a hydroxyl terminated polyester, a hydroxyl terminated polyether, a hydroxyl terminated polyearbonate or mixtures thereof (hydroxyl terminated intermediates are commonly referred to as polyols), with one or more glycol chain extenders, all of which are well known to those skilled, in the art. U.S. Pat. No. 6,777,466 to Eckstein et al. provides detailed disclosure of processes to provide certain TPU polymers that may be utilized in embodiments of the present invention and is incorporated herein in its entirety.

The polyester-ether intermediate, a hydroxyl terminated, saturated polyester-ether polymer is synthesized by reacting excess equivalents of diethylene glycol with considerably lesser equivalents of an aliphatic, preferably an alkyl, dicarboxylic acid having four to twelve carbon atoms where the most preferred is adipic acid. Other useful dicarboxylic acids include succinic, glutaric, pimelic, suberic, azelaic and sebacic acids. The most preferred polyester-ether intermediate is polydiethylene glycol adipate, In accordance with this aspect of the present invention, excess moles of diethylene glycol are reacted with lesser moles of dicarboxylic acid at levels from about 5 mole percent to about 50 mole percent excess of glycol to provide a hydroxyl terminated polyester-ether oligomer chain having a number average molecular weight between about 500 to 5000 Daltons and preferably between about 700 and 2500. The short chain polyester-ether oligomer contains repeating diethylene ether structures and comprises on an equivalent basis from about 1.05 to 1.5 equivalents of diethylene glycol co-reacted with one equivalent of dicarboxylic acid to produce the low molecular weight polyester-ether oligomer intermediate. The high excess equivalents of diethylene glycol controls the number average molecular weight of the polyester-ether oligomer preferably below 2500 Daltons and further assures a hydroxyl terminated linear polyester-ether oligomer. The polyester-ether oligomers synthesized by reacting the diethylene glycol with lesser equivalents of dicarboxylic acid at temperatures of from about 150° C., to 230° C. in the absence or in the presence of an esterification catalyst such as stannous chloride for tune sufficient to reduce the Acid No. to about zero.

The hydroxyl terminated polyester-ether oligomer intermediate is further reacted with non-hindered diisocyanate along with extender glycol in a so-called one-shot or simultaneous co-reaction of oligomer, diisocyanate, and extender glycol to produce the very high molecular weight linear polyurethane having a weight average molecular weight broadly from about 60,000 to 500,000 Daltons, preferably from about 80,000 to 180,000, and most preferably from about 100,000 to 180,000 Daltons. The weight average molecular weight (Mw) is determined by GPC using a polystyrene standard. The very high molecular weight linear polyurethane based on the polyester ether oligomer in accordance with this aspect of the invention is unique in that an extraordinary high molecular weight polyurethane polymer is produced from a low molecular weight polyester-ether oligomer.

Thermoplastic polyurethanes can be produced by reacting together preferably in a one-shot process the diethylene ether ester oligomer glycol intermediate, an aromatic or aliphatic non-hindered diisocyanate, and an extender glycol, On a mole basis, the amount of extender glycol for each mole of oligomer glycol intermediate is from about 0.1 to about 3.0 moles, desirably from about 0.2 to about 2.1 moles, and preferably from about 0.5 to about 1.5 moles, On a mole basis, the high molecular weight polyurethane polymer comprises from about 0.97 to about 1.02 moles, and preferably about 1.0 moles of non-hindered diisocyanate for every 1.0 total moles of the sum of both the extender glycol and the oligomer glycol (i.e., extender glycol+oligomer glycol=1.0).

Useful non-hindered diisocyanates comprise aromatic non-hindered diisocyanates and include, for example, 1,4-diisocyanatobenzene (PPDI), 4,4′-methylenebis (phenyl isoeyanate) (MDI), 1,5-naphthalene diisocyanate (NDI), m-xylene diisocyanate (XDI), as well as non-hindered, cyclic aliphatic diisocyanates such as 1,4-cyclohexyl diisocyanate (CHDI), and H12 MDI. The most preferred diisocyanate is MDI. Suitable extender glycols (i.e., chain extenders) are aliphatic short chain glycols having two to six carbon atoms and containing only primary alcohol groups. Preferred glycols include diethylene glycol, 1,3 propane diol, 1,4-butane diol, 1,5-pentane diol, and 1,6-hexane diol with the most preferred glycol being 1,4-butane diol.

In accordance with the present invention, the hydroxyl terminated diethylene ether ester oligomer intermediate, the non-hindered diisocyanate, and the aliphatic extender glycol are co-reacted simultaneously in a one-shot polymerization process at a temperature above about 100° C. and usually about 120°C., whereupon the reaction is exothermic and the reaction temperature is increased to about 200° C. to 250° C.

The resulting high molecular weight, thermoplastic polyurethane of this invention is particularly useful as a polymeric binder melt applied, such as by melt coating, to reinforcing fabric, such as Nylon, which can be molded under heat and pressure into a flexible fuel tank for storage of gasoline fuels. The flexible fuel tank can also be made by welding sheets of the TPU coated fabric together to create the fuel tank. Welding can be done by heat welding, RF welding or solvent welding.

In forming the shaped objects, such as fuel tanks, the polymer of the present invention may be plasticized to facilitate the formation of the shaped objects and to provide better temperature snap-back characteristics. The type of plasticizer used can be any of the known plasticizers for use in TPU. The most common plasticizer types used are phthalates with butyl benzyl phthalate being the most preferred. Plasticizers used in the present invention can include phthalate based plasticizers, such as, di-n-butylphthalate, di-2-ethylhexyl phthalate (DOP), di-n-octyl phthalate, diisodecyl phthalate, diisooetyl phthalate, octyldecyl phthalate, butylbenzyl phthalate, and di-2-ethyhexyl phosphate isophthalate; aliphatic ester-based plasticizers, such as di-2-ethylhexyl adipate (DOA), di-n-decyl adipate, diisodecyl adipate, dibutyl sebacate, and di-2-ethylhexyl sebacate; pyrometallitate-based plasticizers, such as trioctyl trimellitate and tridecyl trimellitate; phosphate-based plasticizers, such as tributyl phosphate, tri-2-ethylhexyl phosphate, 2-ethylhexyldiphenyl phosphate, and trieresyl phosphate; epoxy-based plasticizers, such as epoxy-based soybean oil; and polyester-based polymer plasticizers. For applications that are sensitive from the toxicological point of view, such as children's toys and food contact, di-isononyl-eyelohexane-1,2-dicarboxylate (Hexamoll® DINCH from BASF) may be used as the plasticizer. A single plasticizer may be used or a combination of two or more plasticizers, may be used. The selection of the desired plasticizer will depend on the end use application of the TPU polymer, as is well understood by those skilled in the art of formulating TPU, The amount of plasticizer used, if present, is from about 0.1 to about 30.0 percent by weight of the polyurethane composition. Preferably, the level of plasticizer is from about 5.0 to about 20.0 percent by weight of the polyurethane composition.

For some applications, auxiliary additives may be used in the TPU compositions of this invention. Additives such as colorants, antioxidants, antiozonates, light stabilizers, and the like may be used in the TPU composition. Preferably, auxiliary additives are present in small amounts, such as from 0 to 5, and more preferably from 0.1 to 1 weight percent of the TPU composition. Inert tillers, such as talc, clay, calcium carbonate and the like, may be used in amounts of from 0 to 50 weight percent of the TPU composition. Preferably, inert fillers are not present in the TPU composition. If flame and smoke retardants are used, they are typically present in amounts of from 5-50 weight percent of the TPU composition.

The merits of the present invention will be better understood by referring to the followino illustrative examples.

### EXAMPLES

Samples of polyurethane polymers in accordance with the present invention were prepared and subjected to fuel immersion testing in E85 fuel blend with the results indicated hereinafter in Table 1. To provide contrast to the polymers of the present invention, commercial polyurethane compositions were also prepared and those results are presented in Table 1, as well.

### Example 1

A preheated (70° C.), agitated holding tank was charged with 100 parts by weight of poly(diethylene ether adipate) glycol (PDEEAG; Lexorez 1100-110 from Inolex) having number average molecular weight of 1000 Daltons and 0.5 parts by weight each of Stabilizer 7000F (Rasehig) and Irganox 1010 (Ciba). A second preheated (50° C.), agitated holding tank was charged with 1,4-hutanediol (BDO; Lyondell). A third preheated (55° C.), agitated holding tank was charged with 4,4′-methylenebis(phenylisocyanate) (MDI; Bayer).

A polyurethane composition was formed on a continuous basis by metering the PDEEAG solution (47.88 parts by :weight), BDO (10.66 parts by weight), and MDI (41.46 parts by weight) into a static mixer with rapid mixing to form 100 parts by weight of polyurethane polymer. The polymer melt was added to a twin-serew extruder (Werner & Pfleiderer) which was heated to 180-200° C. where the conversion continued, 0.3 parts by weight per 100 parts by weight of polyurethane polymer of ethylene bis(stearamide) (Acrawax C, Lonza) was added into an entry port along the extruder. The polymer mixture was conveyed to an underwater pelietizer. The pellets were collected into a heated (105° C.) silo and dried for about 3 hours.

### Example 2

A preheated (70° C.), agitated holding tank was charged with 100 parts by weight of PDEEAG having number average molecular weight of 1000 Daltons, 23.54 parts by weight of benzyl butyl phthalate (Santicizer 160 from Ferro Corp.) and 0.6 parts by weight each of Stabilizer 7000F and Irganox 1010, A second preheated (50°C.), agitated holding tank was charged with BDO. A third preheated (55° C.) agitated holding tank was charged with MDI.

A polyurethane composition was formed on a continuous, basis by metering the PDEEAG solution (5314 parts by weight), BDO (9.59 parts by weight). and MDI (37.28 parts by weight) into a static mixer with rapid mixing to form 100 parts by weight of polyurethane polymer. The polymer melt was added to a twin-screw extruder which was heated to 180-200° C. where the conversion continued, 0.3 parts by weight per 100 parts by weight of polyurethane polymer of ethylene bis(stearamide) was added into an entry port along the extruder. The polymer mixture was conveyed to an underwater pedetizer. The pellets were collected into a heated (105° C.) silo and dried for about 3 hours.

### Example 3

A preheated (70° C.), agitated holding tank was charged with 100 parts by weight of PDEEAG having number average molecular weight of 1000 Daltons, 53.03 parts by weight of benzyl butyl phthalate, and 0.66 parts by weight each of Stabilizer 7000F and Trganox 1010. A second preheated (50° C.), agitated holding tank was charged with BDO. A third preheated (55° C.), agitated holding tank was charged with MDI.

A polyurethane composition was formed on a continuous basis by metering the PDEEAG solution (58.39 parts by weight), BDO (851 parts by weight), and MDI (33.10 parts by weight) into a static mixer with rapid mixing to form 100 parts by weight of polyurethane polymer. The polymer melt was added to a twin-screw extruder which was heated to 180-200′C where the conversion continued, 0.3 parts by weight per 100 parts by weight of polyurethane polymer of ethylene bis(stearamide) was added into a port along the extruder. The polymer mixture was conveyed to an underwater pelletizer. The pellets were collected into a heated (105° C.) silo and dried for about 3 hours.

### Example 4

A preheated (70° C.), agitated holding tank was charged with 100 parts by weight of PDEEAG having number average molecular weight of 1000 Daltons and 0.72 parts by weight each of Stabilizer 7000F and Irganox 1010. A second preheated (50° C.), agitated holding tank was charged with BDO. A third preheated (55° C.), agitated holding tank was charged with MDI.

A polyurethane composition was formed on a continuous basis by metering the PDEEAG solution (35.49 parts by weight), BDO (14.76 parts by weight), and MDI (49.75 parts by weight) into a static mixer with rapid mixing to form 100 parts by weight of polyurethane polymer. The polymer melt was added, to a twin-screw extruder which was heated to 180-200° C. where the conversion continued, 0.3 parts by weight per 100 parts by weight of polyurethane polymer of ethylene bis(stearamide) was added into a port along the extruder. The polymer mixture was conveyed to an underwater pelletizer. The pellets were collected into a heated (105° C.) silo and dried for about 3 hours.

### Example 5

A preheated (70° C.) agitated holding tank was charged with 100 parts by weight of PDEEAG having number average molecular weight of 1000 Daltons, 31.88 parts by weight of benzyl butyl phthalate, and 0.8 parts by weight each of Stabilizer 7000F and Irganox 1010. A second preheated (50° C.), agitated holding tank was charged with BDO. A third preheated (55° C.), agitated holding tank was charged with MD1.

A polyurethane composition was formed on a continuous basis by metering the PDEEAG solution (41.99 parts by weight), BDO (13.27 parts by weight), and MDI. (44.73 parts by weight) into a static mixer with rapid mixing to form 100 parts by weight of polyurethane polymer. The polymer melt was added to a twin-screw extruder which was heated to 180-200° C. where the conversion continued, 0.3 parts by weight per 100 parts by weight of polyurethane polymer of ethylene bis(stearamide) was added into a port along the extruder. The polymer mixture was conveyed to an underwater pelletizer. The pellets were collected into a heated (105°C.) silo and dried for about 3 hours.

### Example 6

A preheated (70° C.), agitated holding tank was charged with 100 parts by weight of PDEEAG having number average molecular weight of 1000 Daltons, 71.81 parts by weight of benzyl butyl phthalate, and 0.9 parts by weight each of Stabilizer 7000F and Irganox 1010. A second preheated (50° C.), agitated holding tank was charged with BDO. A third preheated (55° C.), agitated holding tank was charged with MDI.

A polyurethane composition was formed on a continuous basis by metering the PDEEAG solution (48.50 partsby weight), BDO (11.78 parts by weight), and MDI (39.72 parts by weight) into a static mixer with rapid mixing to form 100 parts by weight of polyurethane polymer. The polymer melt was added to a twin-screw extruder which was heated to 180-200° C. where the conversion continued, 0.3 parts by weight per 100 parts by weight of polyurethane polymer of ethylene his(stearamide) was added into a port along the extruder. The polymer mixture was conveyed to an underwater pelletizer. The pellets were collected into a heated (105° C.) silo and dried for about 3 hours.

### Control 1

This is a commercial polyurethane composition produced from poly(tetramethylene ether) glycol, BDO, and MDI in a process similar to that described in the examples.

### Control 2

This is a commercial polyurethane composition produced from poly(tetramethylene adipate) glycol, BDO, and MDI in a process similar to that described in the examples.

The polyurethane compositions described in Examples 1-6 and Controls 1 and 2 were extruded into 10-mil and 30-mil thick films on a 1-inch diameter single screw extruder (Killion). These films were used for property testing. Table 1 summarizes property data. These results show that the polyurethanes using PDEEAG have superior resistance to E85 fuel compared to the control polyurethanes. It can also be seen that incorporation of the benzyl butyl phthalate plasticizer further reduces volume swell while improving low temperature flexibility.

TABLE 1
E85 Resistance Data (23° C. Exposure)

| Example: | 1 | 2 | 3 | 4 | 5 | 6 | Control 1 | Control 2 |
|---|---|---|---|---|---|---|---|---|
| Shore Hardness | 95A | — | — | 62D | — | — | 92A | 92A |
| Santicizer 160, % | 0 | 10 | 20 | 0 | 10 | 20 | 0 | 0 |

Originals

| | | | | | | | | |
|---|---|---|---|---|---|---|---|---|
| Stress @ 100% | 2490 | 1660 | 1200 | 4275 | 3240 | 2320 | — | — |
| Strain, psi | | | | | | | | |
| Stress @ 300% | 4870 | 3340 | 2380 | 4635 | 5900 | 4820 | — | — |
| Strain, psi | | | | | | | | |
| Stress @ Break, psi | 7410 | 8090 | 7640 | 4960 | 7400 | 7330 | 8900 | — |
| Strain @ Break, % | 415 | 475 | 525 | 360 | 360 | 420 | 465 | — |

Immersion (6 days)

| | | | | | | | | |
|---|---|---|---|---|---|---|---|---|
| Stress @ 100% | 815 | 825 | 775 | 1300 | 1120 | 1160 | — | — |
| Strain, psi | | | | | | | | |
| Stress @ 300% | 1570 | 1600 | 1450 | 3490 | 2800 | 2840 | — | — |
| Strain, psi | | | | | | | | |
| Stress @ Break, psi | 4580 | 5030 | 4980 | 6830 | 5720 | 5860 | 4800 | — |
| Strain @ Break, % | 555 | 560 | 590 | 435 | 420 | 430 | 635 | — |
| Volume change, % | 18.1 | 4.8 | −6.4 | 11.8 | 9.4 | −3.5 | 26 | — |
| Weight change, % | 11.4 | 0.9 | −9.4 | 8.3 | 4.6 | −7.2 | — | — |
| E85 Permeability, | 40 | 50 | — | 5 | 15 | — | 140 | 1200 |
| g/m² * 24 h; 50% | | | | | | | | |
| RH, 23° C. | | | | | | | | |
| Tg, ° C. (DSC) | −13 | −23 | −36 | 15 | −23 | −33 | −22 | −43 |

Test Methods
Shore Hardness-ASTM D2240
Stress/Strain-ASTM D412
Volume and Weight Change after immersion-ASTM D471
Permeability-ASTM D814

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

1. A high molecular weight, thermoplastic polyurethane characteristically resistant to aliphatic hydrocarbon fuels, said polyurethane adapted for use as an aliphatic hydrocarbon fuel barrier in the construction of flexible fuel containers, the polyurethane comprising the reaction product of a poly(diethylene adipate) glycol reacted with a non-hindered diisocyanate and an aliphatic chain extender.

2. A thermoplastic polyurethane according to claim 1, wherein the diiscyanate is 4,4′-methylene bis(phenyl isocyanate).

3. A thermoplastic polyurethane according to claim 1, wherein the chain extender is 1,4-butanediol.

4. A thermoplastic polyurethane according to claim 3, wherein said diisocyanate is simultaneously reacted with said extender glycol and said poly(diethylene adipate) glycol.

5. A thermoplastic polyurethane according to claim 4 wherein the amount of said extender glycol to said poly(diethylene adipate) glycol is from about 0.1 to about 3.0 moles.

6. A thermoplastic polyurethane according to claim 3, wherein the amount of said diisocyanate is from about 0.97 to 1.02 moles for every total one mole of said poly(diethylene adipate) glycol and said extender glycol, and wherein the weight average molecular weight of said thermoplastic polyurethane is from about 80,000 to about 180,000 Daltons.

7. A thermoplastic polyurethane composition comprising the polyurethane of claim 1 which further includes a plasticizer.

8. The composition of claim 7 wherein the plasticizer is benzyl butyl phthalate.

9. The composition of claim 7 wherein the plasticizer is present in an amount of 0.1 to 30.0% by weight based upon the weight of the polyurethane composition.

10. A shaped thermoplastic polyurethane composition comprising the polyurethane of claim 1 mixed with a plasticizer during the polymerization of the polyurethane composition.

11. A shaped thermoplastic polyurethane container for alcohol-containing fuels made from the polyurethane composition of claim 1 mixed with a plasticizer during the polymerization of the polyurethane composition.

12. A flexible container for storing alcohol containing fuels comprising:
(a) reinforcing fabric; and
(b) at least one thermoplastic polyurethane composition coated onto said fabric;
wherein said thermoplastic polyurethane composition is made by the reaction of:
(i) poly(diethylene adipate) glycol;
(ii) at least one glycol chain extender; and
(iii) at least one diisocyanate.

13. The flexible container of claim 12, wherein said thermoplastic polyurethane composition further comprises a plasticizer.

14. The flexible container of claim 13, wherein said plasticizer is present at a level of from about 5 to about 20 weight percent of said thermoplastic polyurethane composition and said glycol chain extender is 1,4-butanediol.
